(19) United States
(12) Patent Application Publication
(10) Pub. No.: US 2015/0120644 A1
(43) Pub. Date: Apr. 30, 2015

(54) SYSTEM AND METHOD FOR PERFORMING ANALYTICS

(71) Applicant: Edge Effect, Inc., McLean, VA (US)

(72) Inventors: John Stephen Eberhardt, III, Alexandria, VA (US); Richard King, Chevy Chase, MD (US); Amalio Escobar, Arlington, VA (US); Michael Garcia, Ashburn, VA (US)

(73) Assignee: Edge Effect, Inc., McLean, VA (US)

(21) Appl. No.: 14/525,741

(22) Filed: Oct. 28, 2014

Related U.S. Application Data
(60) Provisional application No. 61/896,514, filed on Oct. 28, 2013.
(60) Provisional application No. 62/043,292, filed on Aug. 28, 2014.

(51) Int. Cl. G06F 17/30

(52) U.S. Cl. CPC G06F 17/30563
USPC 707/602

(57) ABSTRACT

A data analytics system includes processing circuitry that receives one or more objects from one or more data sources, and the one or more objects are described based on a common ontology that defines the one or more objects as data objects, manipulation objects, visualization objects, and utility objects. The one or more objects are self-referencing and self-validating. Data pipelines are defined based on input from a user. The data pipelines are executed to perform a runtime instance.

### CROSS-REFERENCE TO RELATED PATENT APPLICATIONS

The present application claims the benefit of the earlier filing date of U.S. provisional application 61/896,514 having common inventorship with the present application and filed in the U.S. Patent and Trademark Office on Oct. 28, 2013 and U.S. provisional application 62/043,292 having common inventorship with the present application and filed in the U.S. Patent and Trademark Office on Aug. 28, 2014, the entire contents of both of being incorporated herein by reference.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Data documentation and loading technologies, such as “extract, transform, and load” (ETL) technologies, enable exposure of data to analytical processes and processing of the data. Analytical technologies can perform manipulations on the data to produce an analytical output that can be represented as mathematical formulae, tabular results, graphical representations of the data, and the like.

### SUMMARY

In an exemplary embodiment, a data analytics system includes processing circuitry that receives one or more objects from one or more data sources, and the one or more objects are described based on a common ontology that defines the one or more objects as data objects, manipulation objects, visualization objects, and utility objects. The one or more objects are self-referencing and self-validating. Data pipelines are defined based on input from a user. The data pipelines are executed to perform a runtime instance.

The foregoing general description of exemplary implementations and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram of a data analytics system, according to certain embodiments;

FIG. 2 is an exemplary illustration of components of the Edge Effect framework, according to certain embodiments;

FIG. 3 is an exemplary illustration of an XACT™ Document Type Description (DTD), according to certain embodiments;

FIGS. 4A-4C are exemplary illustrations of taxonomies within the Edge Effect framework, according to certain embodiments;

FIG. 5 is an exemplary illustration of an architecture for the implementation of the Edge Effect framework, according to certain embodiments;

FIG. 6 is an exemplary illustration of an operating system for data analysis, according to certain embodiments;

FIG. 7 is an exemplary illustration of a data pipeline, according to certain embodiments;

FIG. 8 is an exemplary flowchart of a data analytics process, according to certain embodiments;

FIG. 9 is an exemplary illustration of content ontology, according to certain embodiments;

FIG. 10 is an exemplary illustration of a pipeline editor ontology, according to certain embodiments;

FIGS. 11A-11C are exemplary illustrations of pipe editing, according to certain embodiments;

FIG. 12 is an exemplary illustration of a runtime message-based architecture, according to certain embodiments;

FIG. 13 is an exemplary illustration of a data pipeline execution, according to certain embodiments; and

FIG. 14 is a block diagram of circuitry that implements any of the processors or computer-resources described herein when programmed to perform the processes described herein.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “about,” and similar terms generally refer to ranges that include the identified value within a margin of 20%, 10%, or preferably 5%, and any values there-between.

Aspects of the present disclosure are directed to a framework developed by Edge Effect, Inc. (‘Edge Effect’) that includes a device, system, and associated methodology for describing, assembling, and exposing electronic data, analytical manipulations, and analytical presentations. Specifically, a data analytics system can receive objects from one or more sources and perform data analysis via processing circuitry using self-referencing and self-validating objects. The data analytics system can implement an Edge Effect framework that uses an Extensible Mark-up Language (XML) Analytics Compatibility Toolset (XACT™) to define and manage the self-referencing and self-validating objects. In some implementations, the Edge Effect framework can describe data, analytical operations, visual tools, and the like by pushing semantic knowledge of objects in the data analytics system down to the objects themselves. A standard lexicon to describe the objects used in data analysis can be used to enable implementation of algorithms and data manipulations on a single platform. Details of how the Edge Effect framework performs data analytics are discussed further herein.

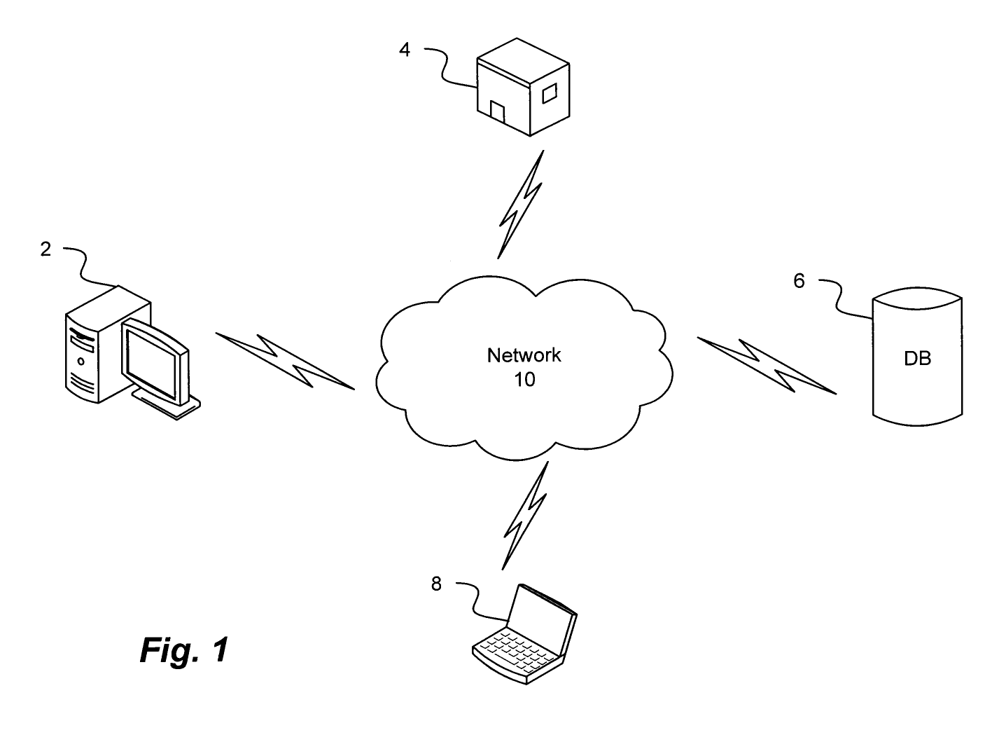

FIG. 1 is a schematic diagram of a data analytics system, according to certain embodiments. In FIG. 1, a computer 2 is connected to a server 4, a database 6 and a mobile device 8 via a network 10. The server 4 represents one or more servers connected to the computer 2, the database 6 and the mobile device 8 via the network 10. The database 6 represents one or more databases connected to the computer 2, the server 4 and the mobile device 8 via network 10. The mobile device 8 represents one or more mobile devices connected to the computer 2, the server 4 and the database 6 via the network 10. The network 10 represents one or more networks, such as the Internet, connecting the computer 2, the server 4, the database 6 and the mobile device 8. In certain implementations, at least one of the computer 2, server 4, database 6, and network 10 can be virtual machines that operate in a cloud environment.

The computer 2 includes an interface, such as a keyboard and/or mouse, allowing a user to interact with the data analytics system to define nodes and pipelines via a Toolbox Unified Markup Language (TUML) which is then transmitted to the server 4 via network 10. Details regarding user interaction with pipeline editing and management will be discussed further herein.

As would be understood by one of ordinary skill in the art, based on the teachings herein, the mobile device 8 or any other external device could also be used in the same manner as the computer 2 to receive pipe editing and management information from an interface and send the pipe editing and management information to server 4 and database 6 via network 10. In one implementation, a user accesses an application on his or her SmartPhone to access and/or execute data pipelines.

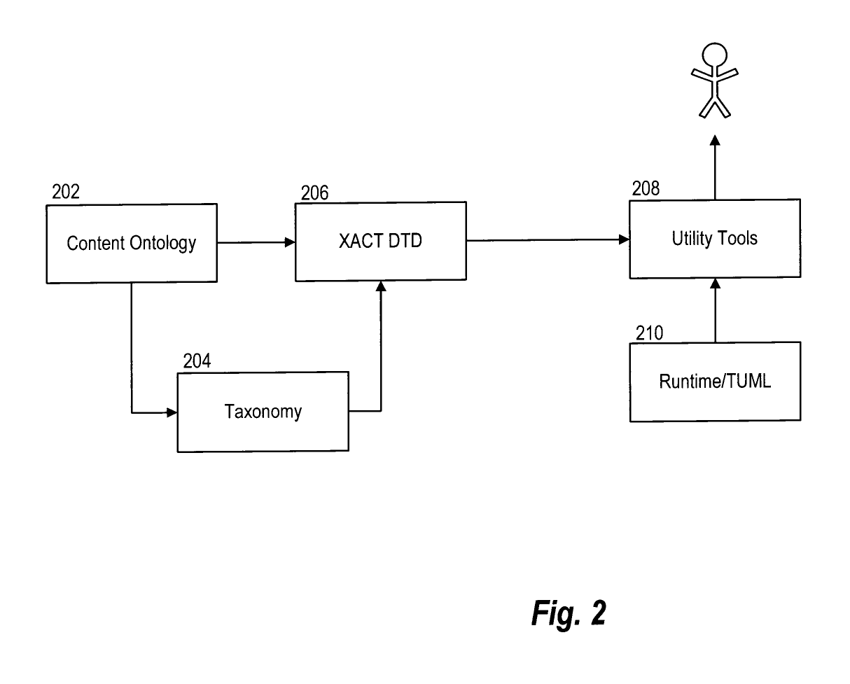

FIG. 2 is an exemplary illustration of components of the Edge Effect framework, according to certain embodiments. The components of the Edge Effect framework include a content ontology 202 that describes the system of objects, such as data source metadata. In addition, taxonomy 204 describes a hierarchy of allowable attributes within the system of objects. Content with a XACT™ Document Type Description (DTD) 206 applies the taxonomy 204 to the objects in the context of the content ontology 202, which allows the objects to be self-referencing and self-validating. Self-referencing and self-validating objects allow the descriptions of objects to be normalized through the use of primitive elements that can be reused in subsequent runtime instances of data pipeline execution.

Utility tools 208 perform management and administrative functions within the Edge Effect Framework, and runtime/TUML 210 documentation describes the analytical pipelines that have been defined by the user that are executed at runtime. The Edge Effect framework is applied to the system of objects, which is presented to a user via an interface at a computer 2 that allows the user to define and manipulate nodes and data pipelines. Details regarding the Edge Effect framework are discussed further herein.

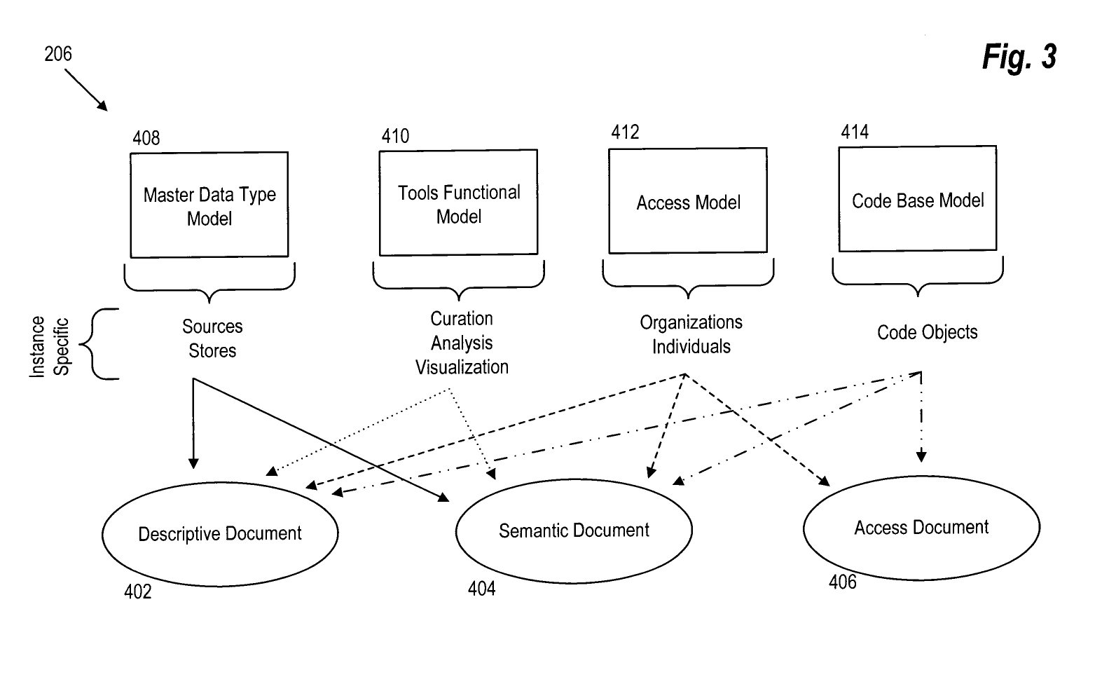

FIG. 3 is an exemplary illustration of an XACT™ Document Type Description (DTD) 206, according to certain embodiments. The XACT™ DTD 206 is a XML DTD that allows each object instance to be described using the same generic attributes so that individual runtime instances can occur without having to be configured for unique instances that are specific to a data set. However, in certain implementations, metaclasses may exist where an unlimited number of individual instances produce specific runtime instances. Therefore, each object has specific documentation that allows the objects to self-validate, which supports workflows that are configured by a user and are reusable. In certain embodiments, the XACT™ DTD 206 involves assigning sub-document types to each object, which can include a descriptive document 402, a semantic document 404, and an access document 406.

The descriptive document 402 provides basic documentation about each object, such as history, attribution, function, a description of what information the object includes, and the intended purpose of the object. The semantic document 404 describes the inputs and outputs of the object, user interface (UI) requirements, configuration parameters, data payload, and the like. The access document 406 describes specific access provisions and authorizations associated with the object by an owner of the object. In some embodiments, the information in the access document 406 enables third-party sharing and market place access. Each object in the data analytics system has a “passport” that includes the descriptive document 402, semantic document 404, and access document 406.

Each object within the Edge Effect framework has a reference DTD and a reference super-ontology that can be used to validate described values for a specifically configured instance of the object within a class. For example, the reference super-ontology is a reference ontological model that can include a master data type model 408, a tools functional model 410, an access model 412, and a code base model 414. By including the reference super-ontology with the reference DTD, the data analytics system includes a collection of self-validating objects with referential integrity enforced by the reference ontological models.

The master type data model 408 indicates allowable data types, structures, and formats for the data analytics system. The content of the master data type model 408 includes data sources, descriptions, and formats. In addition, the attributes of the master data type model 408 include data types and an access protocol for the data analytics system. For each specific runtime instance, data sources and stores are established for the master data type model 408 that are included in the descriptive document 402 and the semantic document 404.

The tools functional model 410 indicates allowable objects, allowable languages, and allowable functions for the data analytics system. The content of the tools functional model 410 includes functions descriptions, sources, configurations, and pointers for the objects. In addition, the attributes of the tools functional model 410 include inputs and outputs for the data analytics system. For each specific runtime instance, curation, analysis, and visualization operations are established for the tools functional model 410 that are included in the descriptive document 402 and the semantic document 404.

The access model 412 defines how data authentication and access are managed in the data analytics system. The content of the access model 412 includes entities, roles classes, and access classes for the data analytics system. In addition, the attributes of the access model 412 indicate organizations, roles, and levels for the data analytics system. For each specific runtime instance, organizations and individuals are established for the access model 410 that are included in the descriptive document 402, the semantic document 404, and the access document 406.

The code base model 414 defines attributes of allowable languages and formats of the data analytics system. The content of the code base model 414 includes provenance of objects, languages, and allowable configurations and/or formats of the code that describes the objects. In addition, the code base model 414 specifies pointers and system requirements for the objects that allow them to function within the Edge Effect framework. For each specific runtime instance, code objects are established for the code base model 414 that are included in the descriptive document 402, the semantic document 404, and the access document 406.

Referring back to FIG. 2, within the construct of the content ontology 202 and the XACT™ DTD 206, the taxonomy 204 is used to determine which attributes are valid or allowable for an object in the data analytics system, according to certain embodiments. Together, the content ontology 202, XACT™ DTD 206, and the taxonomy 204 enforce referential integrity among the objects of the data analytics system and allow disparate data, manipulation objects, and visualization objects to be integrated in a drag-and-drop fashion. In certain embodiments, drag-and-drop integration of data and objects means that a user can identify one or more objects and/or data to include in a run-time execution of the data analytics system without having to perform operations to customize the data for each runtime instance. The content ontology 202, XACT™ DTD 206, and the taxonomy 204 ensure that semantic knowledge of the objects is pushed down to the objects themselves, which allows the objects to self-reference and self-validate during execution.

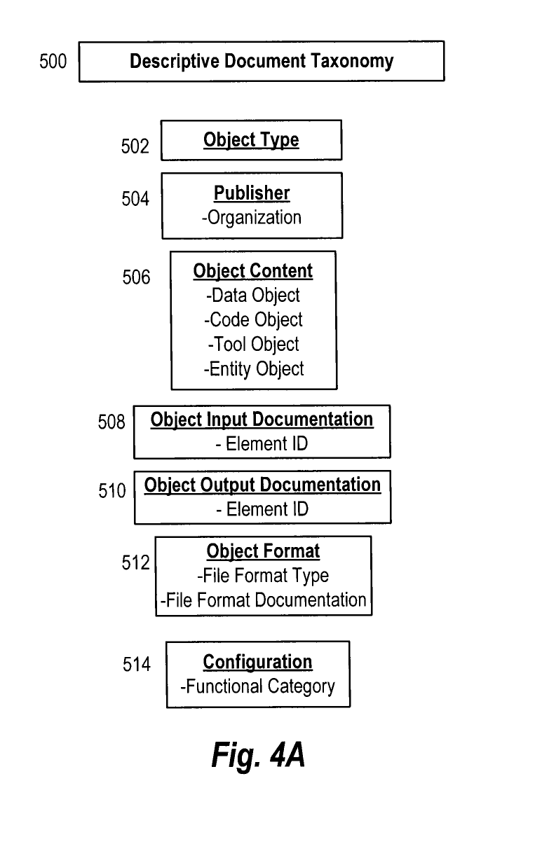

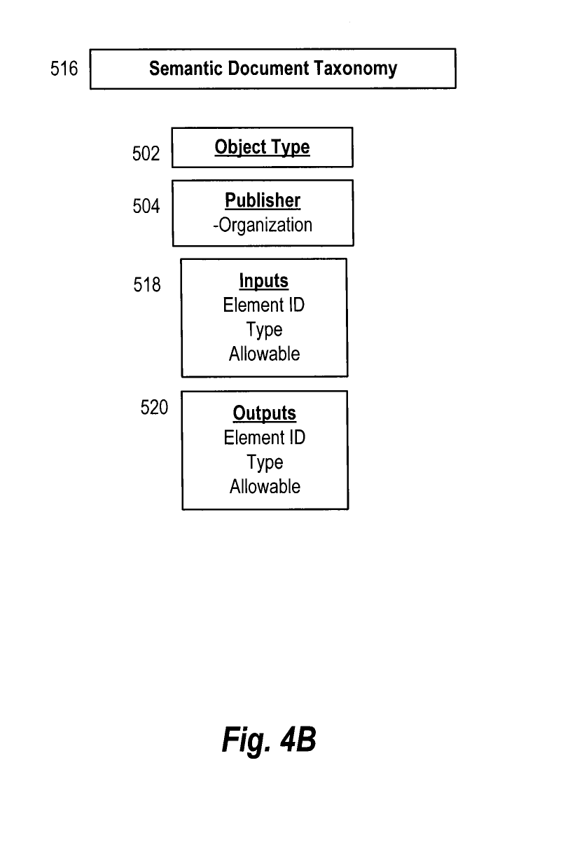

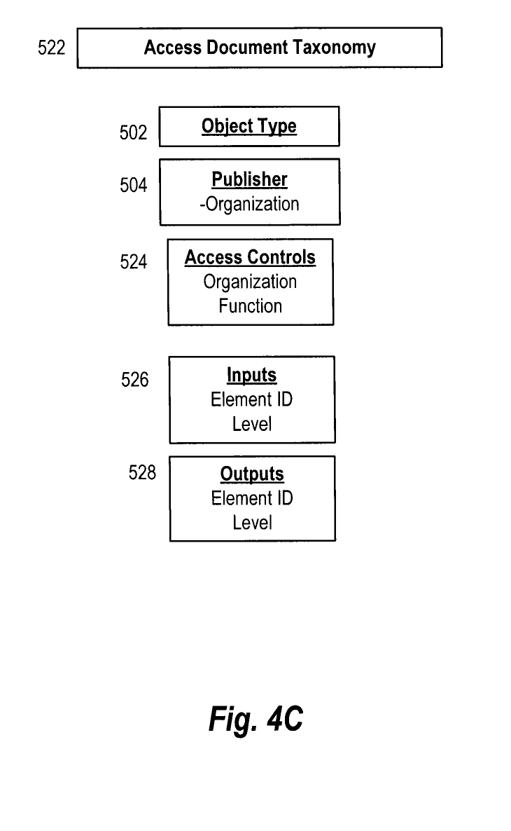

FIGS. 4A-4C are exemplary illustrations of taxonomies within the Edge Effect framework. FIG. 4A is an exemplary illustration of descriptive document taxonomy 500, according to certain embodiments. The descriptive document taxonomy 500 provides allowable attributes for the descriptive document 402 that are assigned to an object in the data analytics system. The descriptive document taxonomy 500 specifies an object type 502, publisher 504, object content 506, object input documentation 508, object output documentation 510, object format 512, and object format 514.

In certain embodiments, the object type 502 includes the allowable object types for the descriptive document taxonomy 500, such as data objects, manipulation objects, visualization objects, or utility objects. The publisher 504 includes the organization and/or individual to which the object belongs. The object content 506 includes allowable content for the object being described. For example, for data objects, the taxonomy specify the data type, location, access protocol, descriptive information, set structure types, and format of the object. For tool objects, the taxonomy specifies the tools category type, location, access protocol, descriptive information, function (e.g., curation, analysis, visualization), and language. For code objects, the taxonomy specifies location of the object or application programming interface (API), access protocol for a driver or API, descriptive information that can include name, free text description, and user documentation, and a language, such as a programming language or API documentation. Entity objects include data pertaining to organizations or individuals associated with the object.

The object input documentation 508 and object output documentation 510 include element identification (ID) that provides a description and/or quality documentation for the inputs and outputs of the object. The object format 512 includes allowable file format and types and documentation. The configuration 514 includes functional categories, such as sub-function selections and objection/function specific configuration parameters.

FIG. 4B is an exemplary illustration of semantic document taxonomy 516, according to certain embodiments. The semantic document taxonomy 516 provides allowable attributes for the semantic document 404 that is assigned to an object in the data analytics system. The semantic document taxonomy 516 specifies an object type 502, publisher 504, inputs 518, and outputs 520.

The object type 502 includes the allowable object types for the semantic document taxonomy 506, such as data objects, manipulation objects, visualization objects, or utility objects. The publisher 504 includes the organization and/or individual to which the object belongs. One or more inputs 518 and outputs 520 are indicated in the semantic document taxonomy 516, and an element ID, type, and allowable inputs are specified. For example, the type includes whether the inputs are a string, variable character field (varchar), Boolean/binary, numeric/floating point, integer, binary large object (BLOB)/Analog (e.g., video, audio), and the like.

FIG. 4C is an exemplary illustration of access document taxonomy 522, according to certain embodiments. The access document taxonomy 522 provides allowable attributes for the access document 406 that is assigned to an object in the data analytics system. The access document taxonomy 522 specifies an object type 502, publisher 504, access controls 524, inputs 526, and outputs 528.

In certain embodiments, the object type 502 includes the allowable object types for the access document taxonomy 522, such as data objects, manipulation objects, visualization objects, or utility objects. The publisher 504 includes the organization and/or individual to which the object belongs. The access controls 524 indicate how access is controlled to an object by specifying an organization, group, and/or level of access control. In addition, the inputs 526 and outputs 528 of the access document taxonomy 522 indicate element ID's and specific access provisions for the inputs and outputs of the object.

Referring back to FIG. 2, the Edge Effect framework for the data analytics system has utility tools 208 that allow the environment of the Edge Effect framework to run and support comingled analytical pipelines within the data analytics system. In addition, the utility tools 208 perform management and administrative functions that allow the user to interact with the Edge Effect framework to view the relationships between objects and manipulate the data nodes and pipelines. In some implementations, the utility tools 208 include cloud utilities and XACT™ utilities. Cloud utilities are pieces of cloud infrastructure that manage data storage, object indices, load balancing, virtual machines, verification, and validation. XACT™ utilities support the implementation and referential integrity of the XACT™ architecture and include tools for publishing specific instances of the XACT™ DTD 206, validation of published XACT™ DTD 206 instances, validation of object interfaces in the context of data pipelines, validation of access rights in the context of the data pipelines, and exposure of object indices in content-specific data pipeline editors.

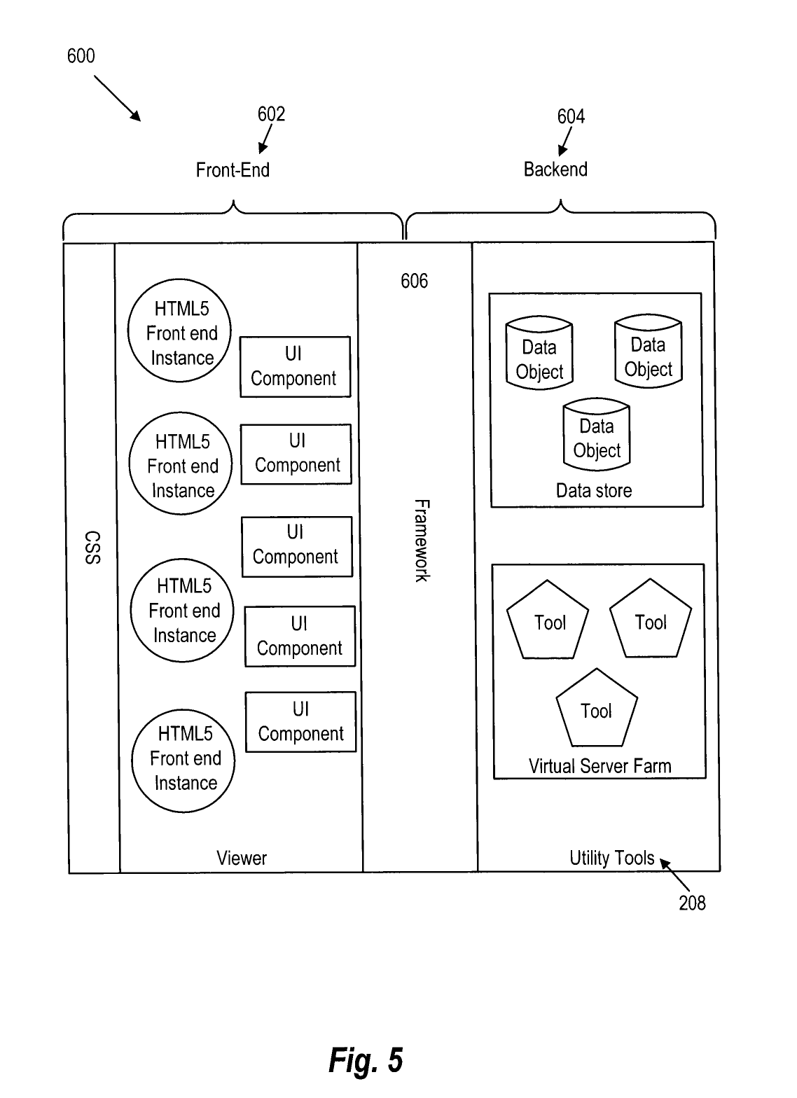

FIG. 5 is an exemplary illustration of an architecture 600 for the implementation of the Edge Effect framework, according to certain embodiments. The architecture 600 for the implementation of objects allows the user to visualize the relationships of objects in the data analytics system in the context of a framework 606, such as the Edge Effect framework, by applying the utility tools 208. In certain implementations, the architecture 600 is implemented using representational state transfer (REST) architecture. In addition, the architecture may be implemented using a service oriented application protocol (SOAP).

The backend 604 of the architecture 600 includes one or more utility tools 208 that can manage the administration and environment of the framework 606, according to certain embodiments. For example, the backend of the architecture 600 includes utilities, such as a data store that includes one or more data objects, which can be data files, databases, sensor data, strings, streaming data, and APIs that are used to collect data. In addition, a virtual server farm includes one or more tools, such as cloud utilities that manage the pieces of cloud infrastructure that manage data storage, virtual machines, and the like.

The backend 604 interfaces with the content of the framework 606 to interpret a series of XACT™ DTDs for each runtime instance. For example, the XACT™ DTD 206 applies the taxonomy 204 to objects in the context of the modeled content ontology 202 to develop the data analytics system with self-referencing, self-validating objects. The utility tools 208 manage how the data is accessed, manipulated, and described through the framework 606.

The front-end 602 of the architecture 600 includes components that enable a user to view the results of an implementation of the framework 606. For example, one or more user interface (UI) components and one or more hyper text mark-up language (HTML5) front-end instance components display the results of each runtime instance of the Edge Effect framework 606 to the user. In addition, cascading style sheets (CSS) are included as part of the front end 602 of the architecture 600 to visually describe documents written in markup languages to the user. The front-end 602 also allows the user to interact with the framework 606 to manage and edit data pipelines, input or select user-defined data, and the like.

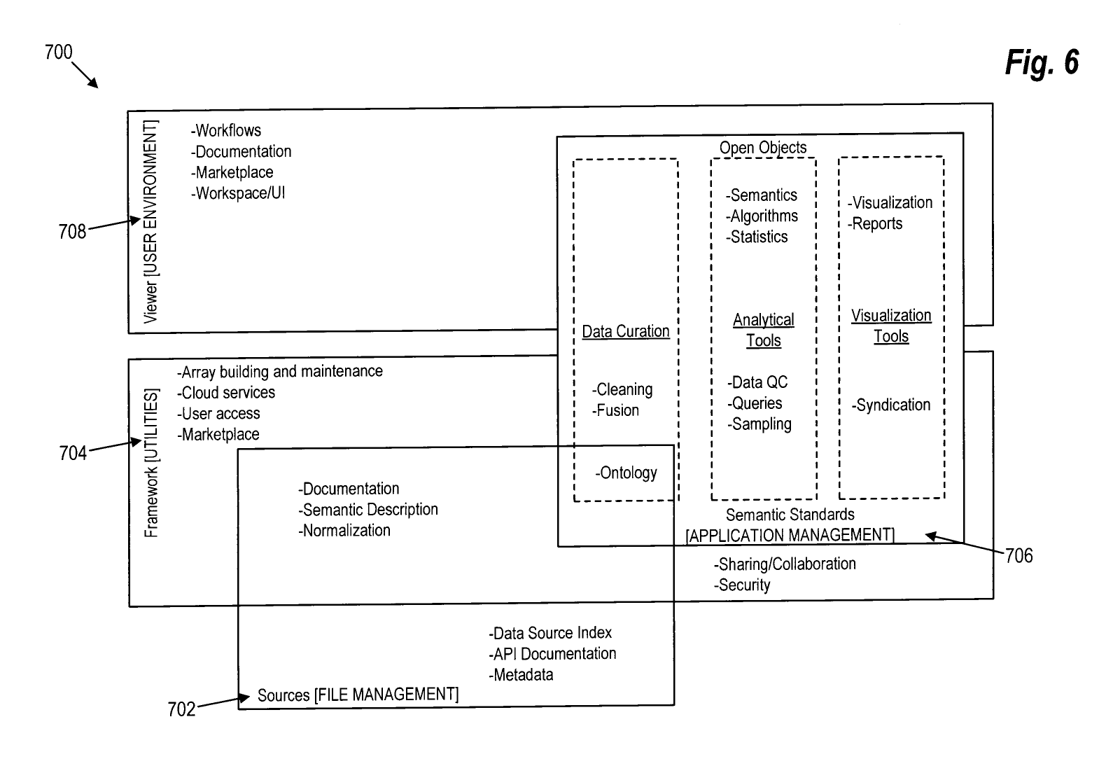

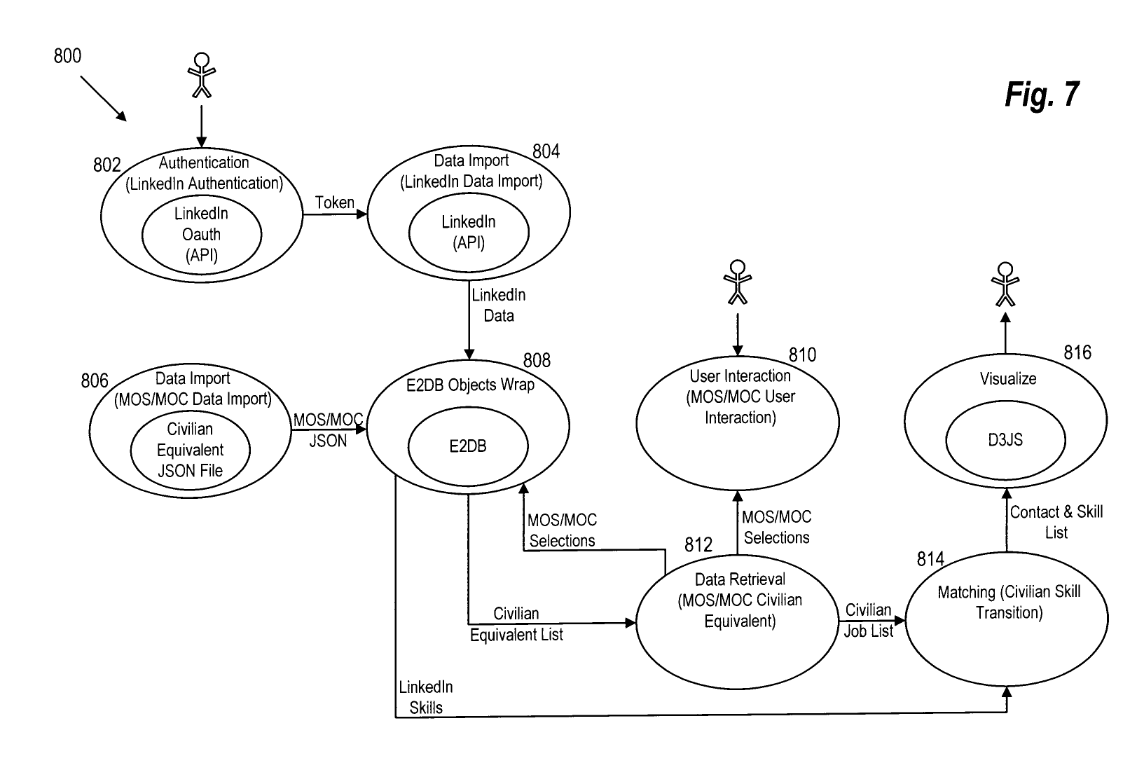

FIG. 6 is an exemplary illustration of an operating system 700 for data analysis, according to certain embodiments. The Edge Effect framework can be translated to an operating system for analytics, and FIG. 7 illustrates how the Edge Effect framework is represented as an operating system 700 that includes components, such as file management 702, utilities 704, application management 706, and user environment 708. In certain embodiments, elements of the Edge Effect framework may overlap into more than one component of the operating system 700.

The file management 702 component of the operating system 700 includes tools and objects for managing data sources in the Edge Effect framework. For example, the file management component 702 includes information that describes the objects in the Edge Effect framework, such as a data source index, API documentation, and metadata. In addition, utility documentation, semantic descriptions of utility tools 208, and normalization information are a part of the file management 702 and the utilities 704 components of the operating system 700. The content ontology 202 of the Edge Effect framework is included in the file management 702, utilities 704, and application management 706 components of the operating system 700.

The utilities 704 component of the operating system 700 includes tools and objects for managing and administering the Edge Effect framework 606. For example, the utilities 704 component includes tools and objects for array building maintenance, cloud services, user access, marketplace management, sharing/collaboration with third-party data sources, and security.

The application management 706 component of the operating system 700 includes tools and objects for managing algorithms and manipulations within the Edge Effect framework 606, which can set semantic standards for the operating system 700. For example, data curation manipulations, analytical tools, and visualization tools are included in the application management 706 component as well as the user environment 708 or the utilities 704 component based on the function of the tool. In certain embodiments, analytical tools such as data quality control (QC), queries, and sampling are also included as utilities 704 components. In addition, analytical tools, such as semantics, algorithms, and statistics, are included as user environment 708 components. Data curation tools, such as data cleaning and fusion tools are included as utilities 704. Visualization tools such as reports and other visualization objects are included in the user environment 708 of the operating system 700. Syndication tools are included as visualization tools in the application management 706 component and in utilities 704.

Referring back to FIG. 2, the runtime/TUML 210 documentation describes analytical data pipelines that allow the self-describing, self-validating objects of XACT™ to describe analytical flows of the data analytics system using a graphical UML editor. The analytical flows can be published into the Edge Effect Framework as UML documents. TUML is implemented using a generic template that a user can manipulate via a graphical interface to describe a use case as a TUML analytical pipeline, or toolbox. Details regarding the implementation of data pipelines are discussed further herein.

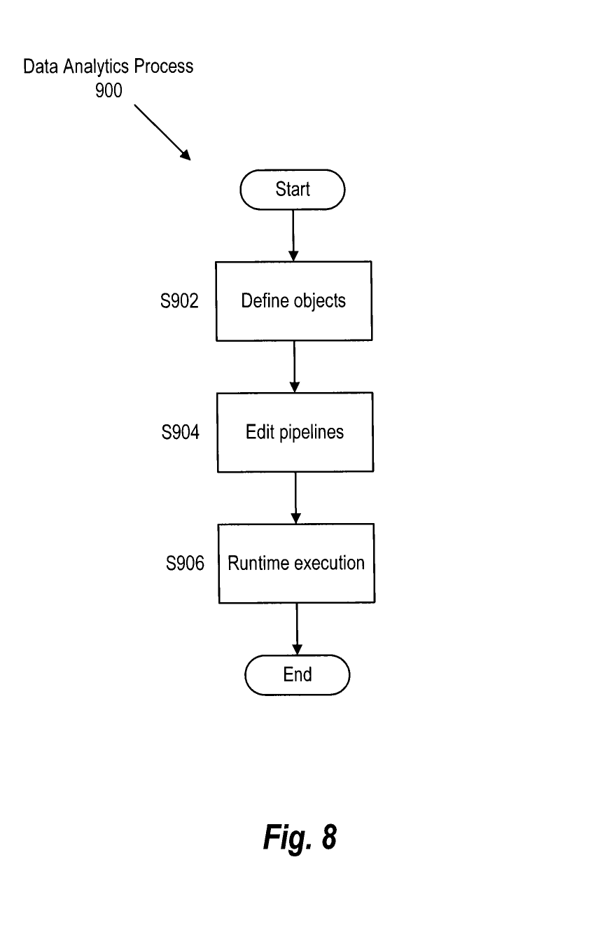

FIG. 7 is an exemplary illustration of a data pipeline 800, according to certain embodiments. In the example, the pipeline 800 uses the Edge Effect framework and a user interface to allow military veterans to use their Military Occupational Specialty (MOS) and/or Military Occupational Code (MOC) number to match their job skills to civilian competencies in order to transition from a military career to a civilian career. The pipeline 800 imports data from sources such as LinkedIn and the US National Resource Directory and performs data manipulations within the Edge Effect framework to identify people and skill sets that approximately match the skill sets of the user. The pipeline 800 is defined by a user and can be employed for a plurality of runtime instances. In FIG. 8, the arrows connecting nodes 802, 804, 806, 808, 810, 812, and 814 represent pipelines, or edges, that can transfer data between the nodes. Details regarding how nodes and pipelines are developed are discussed further herein.

An authentication node 802 receives user authentication information, such as a LinkedIn username and password, and receives a token from an open standard for authorization (OAuth) to access content from the user's LinkedIn profile. The authentication node 802 employs an authentication subclass in the taxonomy 204 of objects to perform the user authentication via the LinkedIn OAuth API.

At node 804, using the taxonomy 204 subclass of data import, the data analytics system imports data from the user's LinkedIn profile, which includes a user's connections and/or occupational skill set. In addition, at node 806, the subclass of data import imports the National Resource Directory MOS/MOC civilian equivalent file that provides civilian career skills that are related to military job specialties. In certain implementations, the civilian equivalent file is a JavaScript Object Notation (JSON) file.

The data imported at node 804 and node 806 is persisted to a data storage node 808, which is referred to as an Edge Effect database (E2DB), according to certain embodiments. The data storage node 808 receives the civilian equivalent MOS/MOC JSON file from the node 806 and receives the LinkedIn profile data from the node 804 in some implementations. The data objects stored in the E2DB may have a wrapper applied to ensure that the objects are compatible with the Edge Effect framework. However, if the backend of the database 6 is relational database management system (RDBMS) that is native and internal to the Edge Effect framework 606, such as MySQL, then the wrapper may not be required.

Node 810 is identified by the taxonomy 204 as having a subclass of user interaction and is a manipulation tool that allows the user to select at least one MOS/MOC from a list. The at least one MOS/MOC selection is then persisted on the E2DB at the data storage node 808. A data retrieval node 812 is a manipulation object that uses the at least one MOS/MOC selection by the user and determines a list of one or more equivalent civilian job titles from the E2DB. In certain embodiments, the determination of the one or more equivalent civilian job titles is made by matching key words or phrases associated with the civilian job titles and the at least one MOS/MOC selection.

In addition, node 814 is a manipulation object that is identified by the taxonomy 204 as having a subclass of matching. In certain embodiments, the node 814 matches the list of one or more equivalent civilian job titles determined at node 812 to the LinkedIn skills retrieved from the user's LinkedIn Profile. The node 814 outputs a list of civilian job titles that correspond to the skills that user identified in the LinkedIn profile as well as a list of user connections with one or more of the same skills.

The results of the matching at node 814 are displayed to the user via node 816, which has a visualization subclass identified by the taxonomy 204. In certain embodiments, node 816 can employ data driven documents (D3JS) to display the pipeline 800 outputs to the user via an interface at the computer 2.

FIG. 8 is an exemplary flowchart of a data analytics process 900, according to certain embodiments. At step S902, the objects of the data analytics system are defined by processing circuitry based on a content ontology so that the objects are self-referencing and self-validating. The objects, or content, are imported from one or more data sources and received the one or more servers 4. For example, the objects from the one or more data sources are described based on the content ontology 202 as discussed previously. Data objects, manipulation objects, visualization objects, and utility objects also have the taxonomy 204 applied, which describes the hierarchy of allowable attributes of the objects. The objects also have at least one XACT™ DTD 206, such as a descriptive document 402, a semantic document 404, and an access document 406 that allow the objects to be described using the same generic attributes.

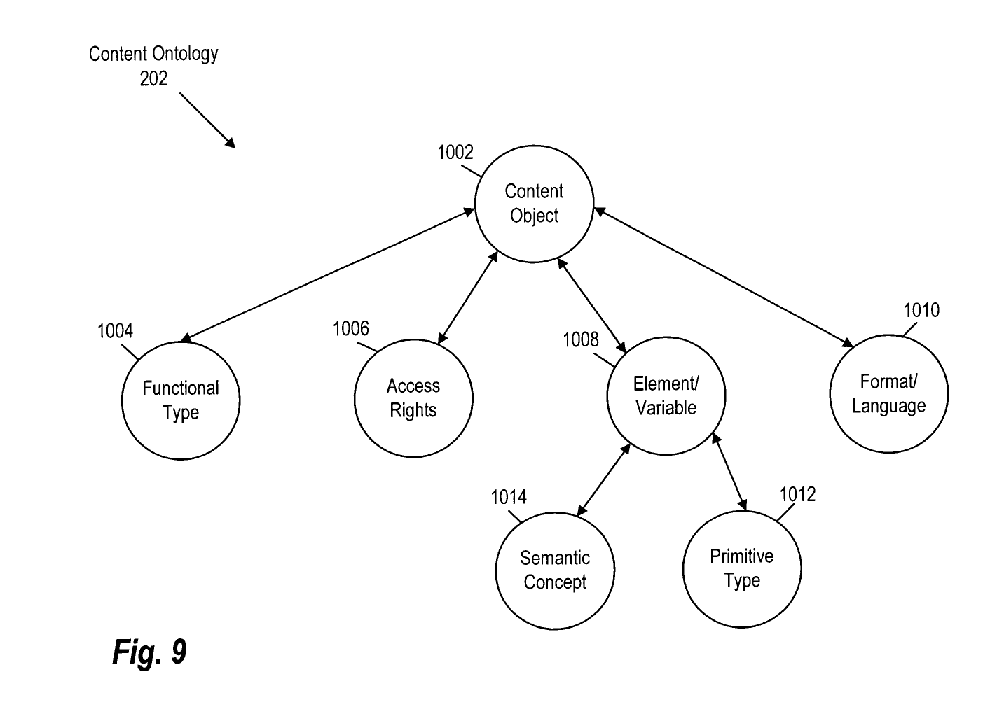

FIG. 9 is an exemplary illustration of content ontology 202, according to certain embodiments. The content ontology 202 is an ontological model that describes allowable semantic attributes of the content within the Edge Effect framework and is an illustration of the integration of the object descriptions by the content ontology 202, taxonomy 204, and XACT™ DTD 206 of step S902. A content object 1002 is an object that includes data, such as a file or code that can be stored in memory. The content object 1002 is described based functional type 1004, access rights 1006, elements and/or variables 1008, and format and/or language 1010.

The function type 1004 defines whether the content object 1002 is a data object, manipulation object, visualization object, or utility object. Data objects are sources of raw data for analysis and can include data files, databases, sensor data, strings, streaming data, and APIs that are used to collect data. The manipulation objects are tools that perform some type of operation on the data and may include transforms, aggregations, data cleaning and curation, statistical analysis, and application of predictive and machine learning algorithms. The visualization objects are tools that present data and the results of analysis in a graphical user interface (GUI) and may include charts, visual representations, reports, mathematical representations, and interactive graphs. The utility objects are objects that facilitate an environment and can include tools that validate documentation, tools that validate object interfaces and data pipelines, object indices, and back end utilities that support virtual machines and the environment.

The elements and/or variables 1008 are individual atomic data elements within the content object 1002. In addition, the elements and/or variables 1008 include characteristics such as primitive type 1012 and semantic concept 1014. The primitive type 1012 includes at least one allowable primitive data type, and the semantic concept 1014 includes a collection of atomic data elements that are related based on predetermined criteria.

Referring back to FIG. 8, at step S904, a user defines data pipelines via a pipeline editor based on the objects defined by the Edge Effect framework. The pipeline editor includes a UI that the user interacts with via a computer 2 or mobile device 8 to access one or more servers that operate within the Edge Effect framework. According to certain embodiments, a data pipeline has at least one node that includes information pertaining to how the objects are described, manipulated, and/or displayed to the user. For example, TABLE 1 illustrates exemplary characteristics of a node. The node includes items such as a name, logic steps, inputs, outputs, flow control choices, data type, and type of server that can execute the node. For each item of the node, TABLE 1 includes a description, type, and cardinality. In addition, the inputs include user inputs that are defined by the user at the UI. The user also defines dependencies between the nodes in the data pipelines at the pipeline editor. For example, the user defines one or more parent nodes that can pass control to one or more dependent children nodes based on the logic steps, user inputs, and flow control choices.

TABLE 1

| Item | Description | Type | Cardinality |
|---|---|---|---|
| Name | Name of Node | String | 1 |
| Logic | Implements logic | Method | 0, 1 |
| | to be executed | | |
| Input Set | Describes set of inputs | Data descriptor | 0-n |
| Output Set | Describes set of outputs | Data descriptor | 0, 1 |
| User Input | Describes set of user input | Data descriptor | 0, 1 |
| Choice | Describes the individual | String | 0-n |
| | values of a domain | | |
| | used for flow control | | |
| Server Type | Describes server that | Language | 1 |
| | can execute the node | | |

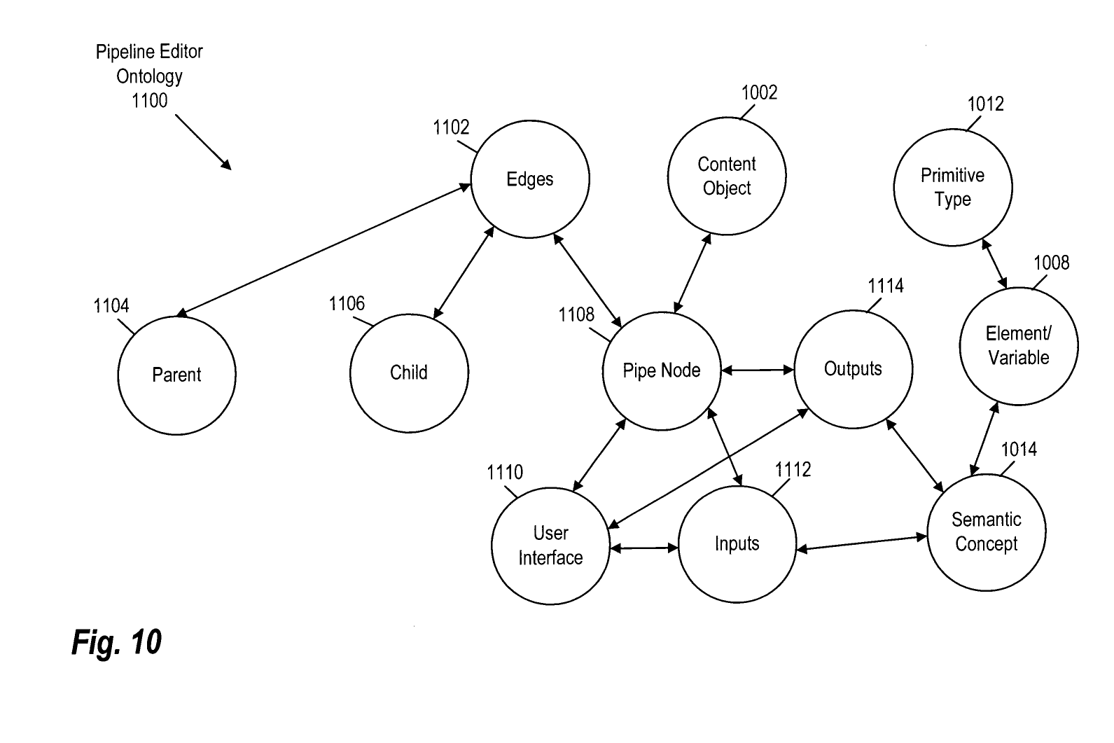

FIG. 10 is an exemplary illustration of a pipeline editor ontology 1100, according to certain embodiments. The pipe editor ontology 1100 may also be referred to as a visual programming ontology that defines the environment in which the user creates and edits data pipelines and includes allowable semantic attributes of the data pipelines. The pipeline editor ontology 1100 illustrates how the object descriptions via the content ontology 202, taxonomy 204, and XACT™ DTD 206 at step S902 are implemented in the context of the pipe editing of step S904. In some implementations, data pipelines are visual representation of a flow of data. For example, edges 1102 denote control and data flow between at least one pipe node 1108. The at least one pipe node 1108 is a juncture of one or more edges 1102 that represents a content object 1002. In addition, parent nodes 1104 or child nodes 1106 are defined based on the dependencies between the at least one pipe node 1108 in the data analytics system. In certain implementations, edges flow from parent nodes 1104 to child nodes 1106.

The at least one pipe node 1108 is defined based on the UI 1110, which is a GUI that allows a user to interact with a pipe node 1108 at runtime. In addition, inputs 1112 and outputs 1114 are data flows that are defined as inputs or outputs based on the direction of the edges 1102. In addition, the inputs 1112 and outputs 1114 are defined based on the semantic concept 1014, elements and/or variables 1008, and primitive type 1012 of the objects that are processed by the pipe node 1108.

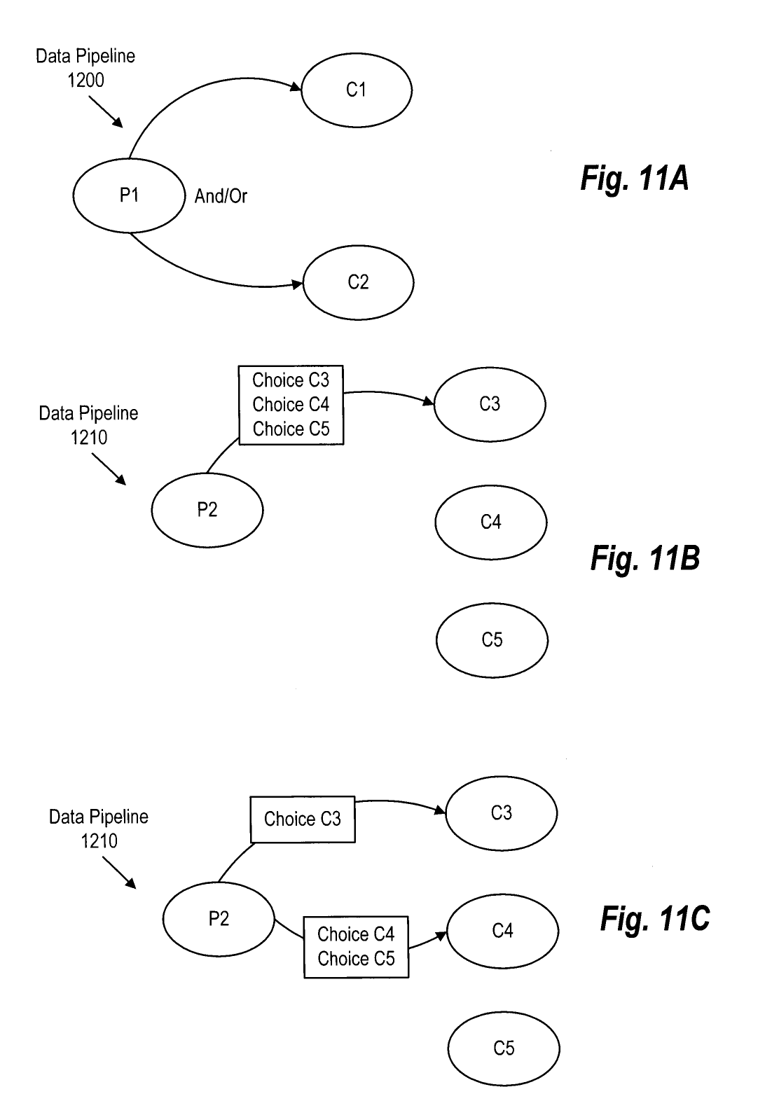

FIGS. 11A-11C are exemplary illustrations of pipe editing, according to certain embodiments. FIG. 11A is an exemplary illustration of a data pipeline 1200 that is implemented with a parent node P1 and two child nodes C1 and C2. The output of the parent node P1 is passed to one or more child nodes, such as the child nodes C1 and C2, after the execution of parent node P1. Based on the logic steps in the parent node P1 or user input, it can be determined that both child nodes C1 and C2 will be executed. In another implementation, the user defines that either child node C1 or child node C2 will be executed based on the logic steps in the parent node P1 or user input.

FIGS. 11B and 11C are exemplary illustrations of a data pipeline 1210 with a choice set, according to certain embodiments. In certain implementations, the choice set is defined by the logic steps in a pipe node or by user input. During pipe editing, for pipe nodes having two or more items in the choice set, when edges are drawn to connect two pipe nodes, the user is presented with a dropdown list that includes one or more choices of the choice set. For example, for data pipeline 1210, when drawing edges between a parent node P2 and child nodes C3, C4, and C5, a user is presented with choice set 1212 as a dropdown list that includes choices C3, C4, and C5. In an implementation, the user selects choice C3 from the dropdown list to draw an edge connecting parent node P2 and child node C3. Since choice C3 was selected from the choice set 1212, in FIG. 11C, choice C3 is removed from the choice set 1214, and the user can select choice C4 or C5 from the dropdown list.

Referring back to FIG. 8, at step S906, a runtime execution of the data pipelines in the edge effect environment is performed by the processing circuitry of the data analytics system. In an implementation, data pipelines are used by an invoking application that invokes the data pipeline via a uniform resource locator (URL). In certain embodiments, the invoking application sends information to the data pipeline through one or more data sources. When the data pipeline execution is complete, the invoking application accesses the resulting data set at an end node.

During the pipeline execution, when a node has completed processing based on the one or more logic steps, control is passed to one or more other nodes based on an outcome. In some embodiments, the outcome is a choice that is selected by the node based on internal logic steps of the node or user input to the node. In addition, control can be passed directly to another node. In some implementations, a nodes may depend on one or more data outputs from at least one previous node so the node may need to wait for the at least one previous node to execute before commencing execution.

Flow control for the data pipeline is determined by the pipe nodes during runtime. In certain embodiments, messages are sent between a pipe controller and the pipe nodes to determine an order of execution between the nodes. In some implementations, an initial pipe node is selected during the pipe editing step S904, and the pipe controller sends a message to the initial pipe node to commence execution.

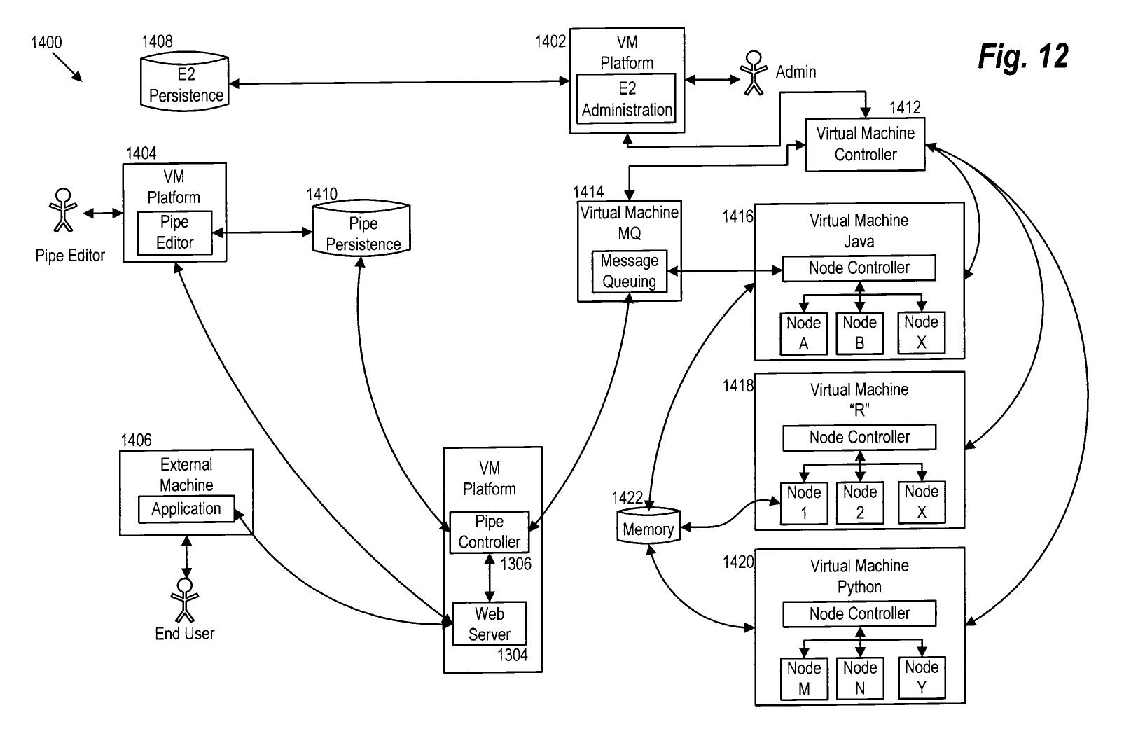

FIG. 12 is an exemplary illustration of a runtime message-based architecture 1400, according to certain embodiments. An administrator manages the Edge Effect framework via an interface for an administration virtual machine (VM) platform 1402 at the computer 2 or mobile device 8. The administration VM platform 1402 communicates with the pipe controller 1306, VM nodes, and web server 1304 to provide continuity between components of the runtime architecture 1400. In certain implementations, the VMs in the runtime architecture 1400 include one or more servers that host the VMs in a cloud environment. Edge Effect data generated during the runtime executions are stored in an Edge Effect persistence database 1408.

A pipe creator creates data pipelines with a pipe editor via an interface for a pipe editing VM platform 1404 at the computer 2 or mobile device 8. Pipe editing data are stored in a pipe persistence database 1410 and are accessed by a pipe controller 1306. During the runtime execution, the pipe controller 1306 manages flow control between the at least one pipe node 1108. The pipe editing VM platform 1404 sends pipe editing data to the web server 1304 so that it can be accessed by an end user via an application at an external machine 1406, such as the computer 2 or mobile device 8. For example, an end user invokes a data pipeline via an invoking application with a UI. In some implementations, the data pipeline is invoked by accessing a web server 1304 via a URL.

After the end user invokes the data pipeline to commence a runtime instance, the at least one pipe node 1108 commences execution according to the logic steps within the at least one pipe node 1108 and/or user input. Supervisor and worker servers process the data within the at least one pipe node 1108. For each runtime instance of the data pipeline, runtime data is obtained and includes runtime statistics, information about the order of node execution, and the like.

In certain embodiments, messages are exchanged between the pipe controller 1306 and the at least one pipe node 1308 via a message queue (MQ) VM 1414. The MQ VM 1414 communicates with the at least one pipe node 1308 via node controllers in a Java node VM 1416, a “R” node VM 1418, and a Python node VM 1420. The Java node VM, “R” node VM, and Python node VM include the at least one pipe node 1108 that are executed as dictated by the pipe controller 1306. In some implementations, additional node VMs are included in the runtime architecture 1400 based on the language being run in the VM. In addition, a VM controller 1412 controls the execution of the at least one pipe node 1108 based on messages received from the VM MQ 1414. Messages and one or more pipe documents are passed between the at least one pipe node 1108 and pipe controller 1308 to manage the order of execution between the pipe nodes. The at least one pipe node 1108 accesses content objects, logic steps, runtime data, and the like from a memory 1422. In addition, the at least one pipe node 1108 stores data from execution in the memory 1422.

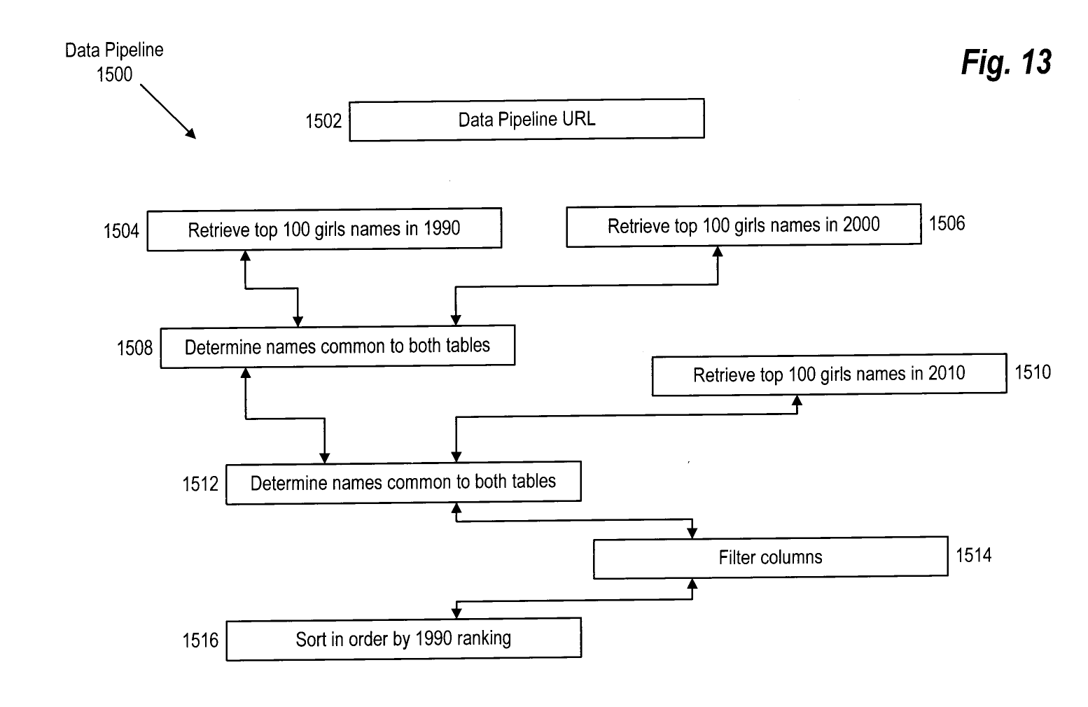

FIG. 13 is an exemplary illustration of a data pipeline execution, according to certain embodiments. In the example of FIG. 15, the Edge Effect framework is used to determine commonalities in naming girls who are born through a number of years. For example, a data pipeline 1500 is accessed by an end user through URL 1502, which initiates execution of the data pipeline 1500 that is created by a user, such as a pipe editor. The data pipeline includes a node 1504 that retrieves a data file that includes a table of one hundred names most frequently given to girls born in the year 1990 along with a frequency count and a frequency ranking for the one hundred names. For example, the name “Jessica” was most frequently given to girls in the year 1990 and has a frequency count of 46,463 and a frequency ranking of one, according to certain embodiments. In addition, node 1506 retrieves a data file that includes a table of one hundred names most frequently given to girls born in the year 2000 along with the corresponding frequency count and frequency ranking. Due to the common lexicon that describes the objects within the Edge Effect framework based on the content ontology 202, taxonomy 204, and XACT™ DTD 206, the data files retrieved at nodes 1504 and 1506 can have different formats, languages, and the like.

In some implementations, the performance of logic steps within node 1508 determines the names that are common to the data files retrieved at nodes 1502 and 1506. The execution of node 1508 results in an output of a table of the common names between the years 1990 and 2000 along with the corresponding frequency counts and frequency rankings in 1990 and 2000. Node 1510 retrieves a data file that includes a table of one hundred names most frequently given to girls born in the year 2010 along with the corresponding frequency count and frequency ranking.

At node 1512, the logic steps determine the names that are common between 1990, 2000, and 2010. The execution of node 1512 result in an output of a table of the common names between the years 1990, 2000, and 2010 along with the corresponding frequency counts and frequencies rankings for 1990, 2000, and 2010. At node 1514, a column filter is applied that sorts columns of the table output from node 1512 based on name and the frequency ranking and frequency count for the years 1990, 2000, and 2010. At node 1516, the columns of the table output from node 1514 are sorted in descending order based on the 1990 frequency ranking. In certain embodiments, node 1516 is the end node, and the table output from 1516 is returned to the end user via an application on an external machine.

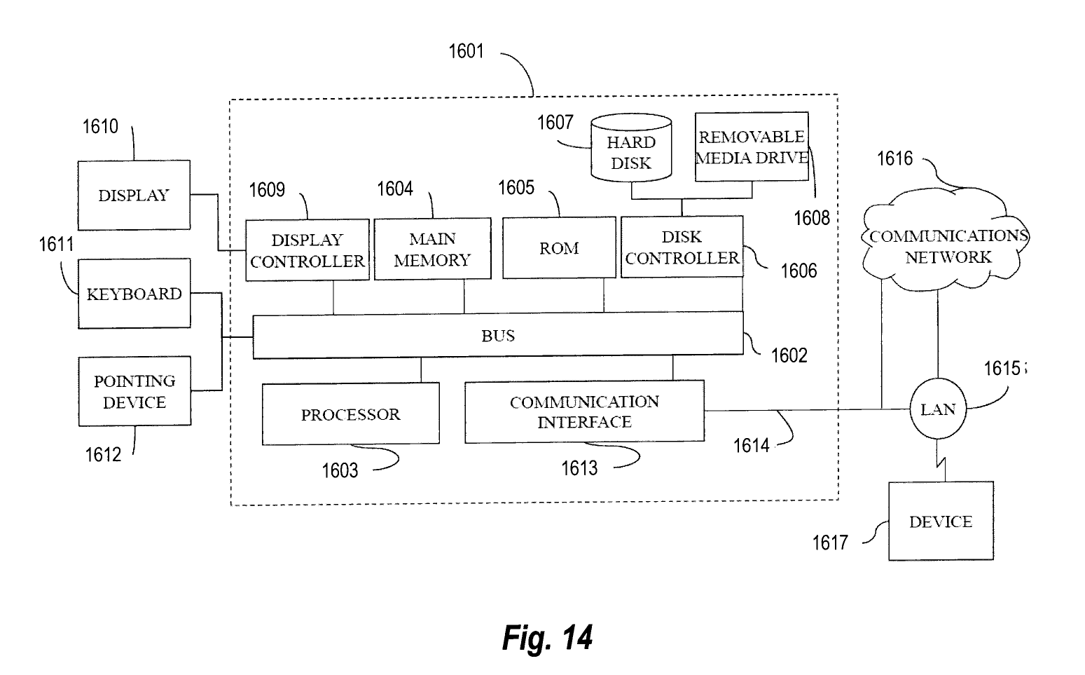

FIG. 14 illustrates a computer system 1601 upon which embodiments of the present disclosure may be implemented.

The computer system 1601 includes a disk controller 1606 coupled to the bus 1602 to control one or more storage devices for storing information and instructions, such as a magnetic hard disk 1607, and a removable media drive 1608 (e.g., floppy disk drive, read-only compact disc drive, read/write compact disc drive, compact disc jukebox, tape drive, and removable magneto-optical drive). The storage devices may be added to the computer system 1601 using an appropriate device interface (e.g., small computer system interface (SCSI), integrated device electronics (IDE), enhanced-IDE (E-IDE), direct memory access (DMA), or ultra-DMA).

The computer system 1601 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1601 may also include a display controller 1609 coupled to the bus 1602 to control a display 1610, such as the touch panel display 101 or a liquid crystal display (LCD), for displaying information to a computer user. The computer system includes input devices, such as a keyboard 1611 and a pointing device 1612, for interacting with a computer user and providing information to the processor 1603. The pointing device 1612, for example, may be a mouse, a trackball, a finger for a touch screen sensor, or a pointing stick for communicating direction information and command selections to the processor 1603 and for controlling cursor movement on the display 1610.

The computer system 1601 performs a portion or all of the processing steps of the present disclosure in response to the processor 1603 executing one or more sequences of one or more instructions contained in a memory, such as the main memory 1604. Such instructions may be read into the main memory 1604 from another computer readable medium, such as a hard disk 1607 or a removable media drive 1608. One or more processors in a multi-processing arrangement may also be employed to execute the sequences of instructions contained in main memory 1604. In alternative embodiments, hard-wired circuitry may be used in place of or in combination with software instructions. Thus, embodiments are not limited to any specific combination of hardware circuitry and software and can include processing circuitry.

As stated above, the computer system 1601 includes at least one computer readable medium or memory for holding instructions programmed according to the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 1601, for driving a device or devices for implementing the invention, and for enabling the computer system 1601 to interact with a human user. Such software may include, but is not limited to, device drivers, operating systems, and applications software. Such computer readable media further includes the computer program product of the present disclosure for performing all or a portion (if processing is distributed) of the processing performed in implementing the invention. The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 1603 for execution. A computer readable medium may take many forms, including but not limited to, non-volatile media or volatile media. Non-volatile media includes, for example, optical, magnetic disks, and magneto-optical disks, such as the hard disk 1607 or the removable media drive 1608. Volatile media includes dynamic memory, such as the main memory 1604. Transmission media, on the contrary, includes coaxial cables, copper wire and fiber optics, including the wires that make up the bus 1602. Transmission media also may also take the form of acoustic or light waves, such as those generated during radio wave and infrared data communications.

Various forms of computer readable media may be involved in carrying out one or more sequences of one or more instructions to processor 1603 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 1601 may receive the data on the telephone line and place the data on the bus 1602. The bus 1602 carries the data to the main memory 1604, from which the processor 1603 retrieves and executes the instructions. The instructions received by the main memory 1604 may optionally be stored on storage device 1607 or 1608 either before or after execution by processor 1603.

The computer system 1601 also includes a communication interface 1613 coupled to the bus 1602. The communication interface 1613 provides a two-way data communication coupling to a network link 1614 that is connected to, for example, a local area network (LAN) 1615, or to another communications network 1616 such as the Internet. For example, the communication interface 1613 may be a network interface card to attach to any packet switched LAN. As another example, the communication interface 1613 may be an integrated services digital network (ISDN) card. Wireless links may also be implemented. In any such implementation, the communication interface 1613 sends and receives electrical, electromagnetic or optical signals that carry digital data streams representing various types of information.

The network link 1614 typically provides data communication through one or more networks to other data devices. For example, the network link 1614 may provide a connection to another computer through a local network 1615 (e.g., a LAN) or through equipment operated by a service provider, which provides communication services through a communications network 1616. The local network 1614 and the communications network 1616 use, for example, electrical, electromagnetic, or optical signals that carry digital data streams, and the associated physical layer (e.g., CAT 5 cable, coaxial cable, optical fiber, etc.). The signals through the various networks and the signals on the network link 1614 and through the communication interface 1613, which carry the digital data to and from the computer system 1601 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1601 can transmit and receive data, including program code, through the network(s) 1615 and 1616, the network link 1614 and the communication interface 1613. Moreover, the network link 1614 may provide a connection through a LAN 1615 to a mobile device 1617 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. A system, comprising:
processing circuitry configured to:
receive one or more objects from one or more data sources,
describe the one or more objects based on a common ontology that defines the one or more objects as at least one of data objects, manipulation objects, visualization objects, and utility objects,
define the one or more objects as self-referencing and self-validating,
define one or more data pipelines based on pipeline input from at least one user device, and
execute at least one runtime instance based on the one or more data pipelines.

2. The system of claim 1, wherein the common documentation scheme includes a taxonomy that is applied to the one or more objects based on at least one allowable attribute.

3. The system of claim 2, wherein the processing circuitry is further configured to assign at least one reference document to the one or more objects based on the taxonomy.

4. The system of claim 3, wherein the at least one reference document includes a descriptive document, a semantic document, and an access document.

5. The system of claim 4, wherein the at least one reference document enables interoperation of the one or more objects.

6. The system of claim 1, wherein the processing circuitry is further configured to manage administration of the one or more objects and the one or more data pipelines via one or more utility tools.

7. The system of claim 6, wherein the one or more utility tools manage a user environment.

8. The system of claim 9, wherein the one or more utilities include analytics utilities and cloud utilities.

9. The system of claim 1, wherein the one or more data pipelines include one or more nodes and at least one edge between the one or more nodes.

10. The system of claim 9, wherein the one or more nodes include a name, one or more logic steps, at least one input, at least one output, at least one flow control choice, and at least one server that can execute the one or more nodes.

11. The system of claim 10, wherein the user defines one or more dependencies between the one or more nodes via a pipeline editor.

12. The system of claim 11, wherein at least one of the one or more logic steps, the at least one flow control choice, and the one or more dependencies between the nodes determine an order of execution of the one or more nodes.

13. The system of claim 10, wherein the at least one flow control choice is determined by the one or more logic steps or by a user selection.

14. The system of claim 1, wherein the at least one user graphically describes the one or more data pipelines via a toolbox user markup language.

15. The system of claim 14, wherein the toolbox user markup language allows the one or more objects described by the common documentation scheme to be interoperable.

16. A non-transitory computer-readable medium having computer-readable instructions thereon which when executed by a computer cause the computer to perform a method for performing data analytics, the method comprising:
receiving one or more objects from one or more data sources;
describing the one or more objects based on a common ontology that defines the one or more objects as at least one of data objects, manipulation objects, visualization objects, and utility objects;
defining the one or more objects as self-referencing and self-validating;
defining one or more data pipelines based on pipeline input from at least one user device; and
executing at least one runtime instance based on the one or more data pipelines.

17. A method for performing data analytics, the method comprising:
receiving, at at least one server, one or more objects from one or more data sources;
describing, via circuitry, the one or more objects based on a common ontology that defines the one or more objects as at least one of data objects, manipulation objects, visualization objects, and utility objects;
defining, via the circuitry, the one or more objects as self-referencing and self-validating;
defining, at the at least one server, one or more data pipelines based on pipeline input from at least one user; and
executing, via the circuitry, at least one runtime instance based on the one or more data pipelines.
